(19) United States
(12) Patent Application Publication
(10) Pub. No.: US 2004/0001441 A1
(43) Pub. Date: Jan. 1, 2004

(54) Apparatus and method for controlling traffic congestion using queue

(75) Inventors: Sung Hwan Kim, Deajeon (KR); Gil Ju Park, Deajeon (KR); Sang Kyu Choi, Deajeon (KR)

Correspondence Address: MERCHANT & GOULD PC, P.O. BOX 2903, MINNEAPOLIS, MN, 55402-0903, US

(73) Assignee: KT Corporation, Kyounggi-do (KR)

(21) Appl. No.: 10/259,267

(22) Filed: Sep. 26, 2002

(30) Foreign Application Priority Data
Jun. 27, 2002 (KR) 2002-36372

(51) Int. Cl. H04L 12/28

(52) U.S. Cl. 370/235

(57) ABSTRACT

The present invention discloses an apparatus and method for controlling traffic congestion using a queue which can detect an abnormal traffic flow by using the queue, and branch and merge traffic classes according to the traffic congestion. In the abnormal traffic flow, the apparatus for controlling traffic congestion using the queue performs branch control in a congestion state and merge control in a non-congestion state by using a branch counter for accumulating a traffic which is not stored but discarded, and a merge counter for recording a difference between a transmission capacity allocated to the corresponding traffic flow and a volume of the actually-transmitted traffic, thereby improving quality of service.

### BACKGROUND OF THE INVENTION

1. Field of the Invention

The present invention relates to an apparatus and method for controlling traffic congestion using a queue, and in particular to an apparatus and method for controlling traffic congestion using a queue which can provide high quality of service (QoS) in traffic flows by controlling congestion of an abnormal traffic during the internet traffic transmission.

2. Description of the Background Art

In a queuing mechanism for controlling congestion of an internet traffic, queues must be generated by traffic flows in order to guarantee the QoS of the whole traffic flows.

However, it is technically difficult to generate queues by traffic flows. In addition, the congestion control is performed on the whole traffic flows, to increase time consumption.

There are thus increasing demands for an apparatus for guaranteeing the QoS of the whole traffic flows merely by controlling congestion of an abnormal traffic of the traffic flows.

### SUMMARY OF THE INVENTION

Accordingly, it is an object of the present invention to detect an abnormal traffic flow by using a queue and branch and merge traffic classes on the basis of the traffic congestion.

In order to achieve the above-described object of the invention, there is provided an apparatus for controlling traffic congestion using a queue, including: a traffic processing unit for storing an arrived traffic in a queue, transmitting the stored traffic, branch-counting a discarded traffic, and merge-counting a transmitted traffic; a traffic processing information storing unit for storing processing information branch and merge-counted in the traffic processing unit; and a queue managing unit for branching and merging traffic classes according to the counted processing information.

There is also provided a method for controlling traffic congestion using a queue, including: a first step for storing an arrived traffic in a queue, transmitting the stored traffic, branch-counting a discarded traffic, and merge-counting a transmitted traffic; a second step for storing branch and merge-counted processing information; and a third step for branching and merging traffic classes according to the counted processing information.

### BRIEF DESCRIPTION OF THE DRAWINGS

The present invention will become better understood with reference to the accompanying drawings which are given only by way of illustration and thus are not limitative of the present invention, wherein:

FIG. 1 is a structure diagram illustrating an apparatus for controlling traffic congestion using a queue in accordance with the present invention;

FIG. 2 is a concept diagram illustrating the apparatus for controlling traffic congestion using the queue in accordance with the present invention;

FIG. 3 is a flowchart showing a traffic transmission procedure of a method for controlling traffic congestion using a queue in accordance with the present invention;

FIG. 4 is a flowchart showing a traffic processing procedure of the method for controlling traffic congestion using the queue in accordance with the present invention; and

FIG. 5 is a tree diagram illustrating branch and merge processes of the method for controlling traffic congestion using the queue in accordance with the present invention.

### DETAILED DESCRIPTION OF THE PREFERRED EMBODIMENTS

An apparatus and method for controlling traffic congestion using a queue in accordance with a preferred embodiment of the present invention will now be described in detail with reference to the accompanying drawings.

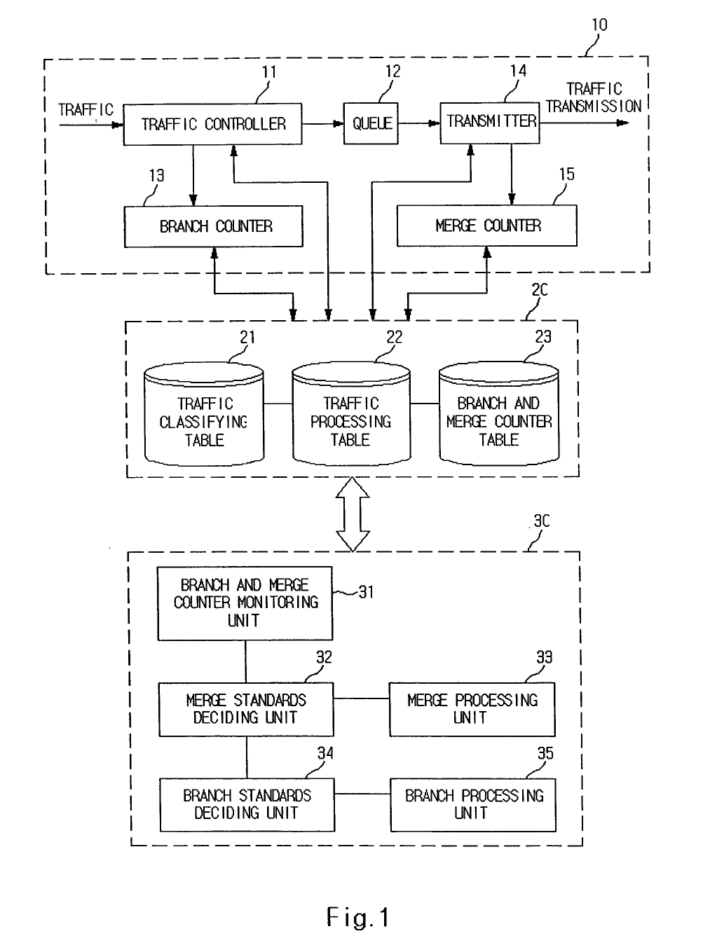

FIG. 1 is a structure diagram illustrating the apparatus for controlling traffic congestion using the queue in accordance with the present invention.

Referring to FIG. 1, the apparatus for controlling traffic congestion includes: a traffic processing unit 10 for storing and transmitting an arrived traffic; a traffic processing information storing unit 20 for storing traffic classification standards, processing standards and traffic processing information; and a queue managing unit 30 for monitoring the traffic processing information stored in the traffic processing information storing unit 20, and merging and branching classes.

Here, the traffic processing unit 10 is composed of: a traffic controller 11 for classifying a class of the arrived traffic; a queue 12 for storing the traffic from the traffic controller 11; a branch counter 13 for accumulating a volume of the traffic which is not stored in the queue 12 but discarded; a transmitter 14 for transmitting the traffic stored in the queue 12 according to a transmission capacity allocated to the corresponding traffic class; and a merge counter 15 for recording a difference between the transmission capacity allocated to the traffic class and the volume of the actually-transmitted traffic.

The traffic processing information storing unit 20 includes: a traffic classifying table 21 for storing traffic classification standards; a traffic processing table 22 for storing a queue size and transmission capacity allocated to each traffic class, and also storing arrived traffic discard standards and transmission standards; and a branch and merge counter table 23 for storing values accumulated in the branch counter 13 and the merge counter 15 and branch and merge standards.

In addition, the queue managing unit 30 has: a branch and merge counter monitoring unit 31 for monitoring the branch and merge counter values stored in the branch and merge counter table 23; a merge standards deciding unit 32 for deciding the merge standards; a merge processing unit 33 for merging the classes according to the decision result of the merge standards deciding unit 32; a branch standards deciding unit 34 for deciding the branch standards; and a branch processing unit 35 for branching the classes according to the decision result of the branch standards deciding unit 34.

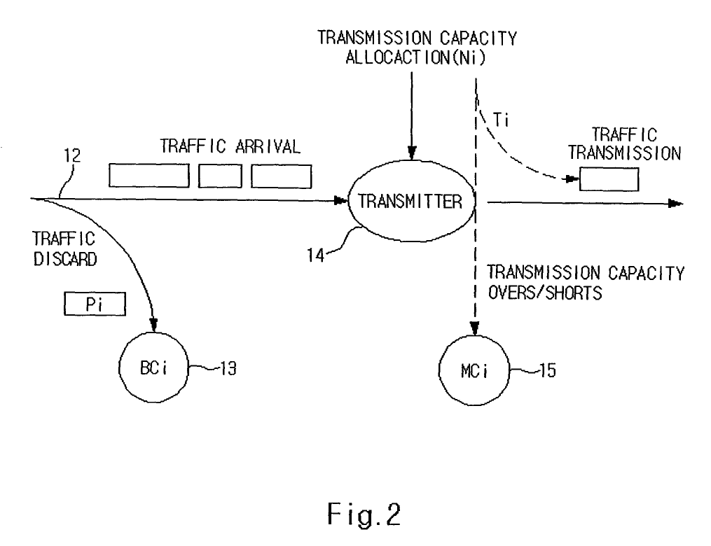

FIG. 2 is a concept diagram illustrating the apparatus for controlling traffic congestion using the queue in accordance with the present invention.

In a traffic flow classified into a few traffic classes, the queue 12 and the transmission capacity are allocated to each traffic class.

When the traffic arrives, the traffic controller 11 classifies the traffic with reference to the traffic classification standards previously stored in the traffic classifying table 21 of the traffic storing unit 20. Thereafter, the arrived traffic is stored in the queue 12. When the traffic is discarded, the volume of the discarded traffic is accumulated in the branch counter 13.

Here, when the discarded traffic is increased, the value of the branch counter 13 is increased. That is, when it is presumed that the size of the discarded traffic is Pi and the previous value of the branch counter is BCi, the current value BCi of the branch counter 13 is represented by following formula 1:

BCi=BCi+Pi <Formula 1>

The transmitter 14 transmits the traffic stored in the queue 12 according to the transmission capacity allocated to the traffic class, and records the difference between the transmission capacity allocated to the traffic class and the volume of the actually-transmitted traffic on the merge counter 15.

That is, when it is presumed that the transmission capacity allocated to the traffic class is Ni, the volume of the actually-transmitted traffic is Ti and the previous value of the merge counter is MCi, the current value MCi of the merge counter 15 is represented by following Formula 2:

MCi=MCi+(Ni−Ti) <Formula 2>

Here, the values of the branch counter 13 and the merge counter 15 are varied while the traffic is discarded or transmitted. The value of the merge counter 15 is reflected to a parent node of the corresponding traffic class.

Accordingly, the values of the branch counter 13 and the merge counter 15 obtained in Formulae 1 and 2 are stored in the branch and merge counter table 23 and used to decide whether the class satisfies the branch and merge conditions.

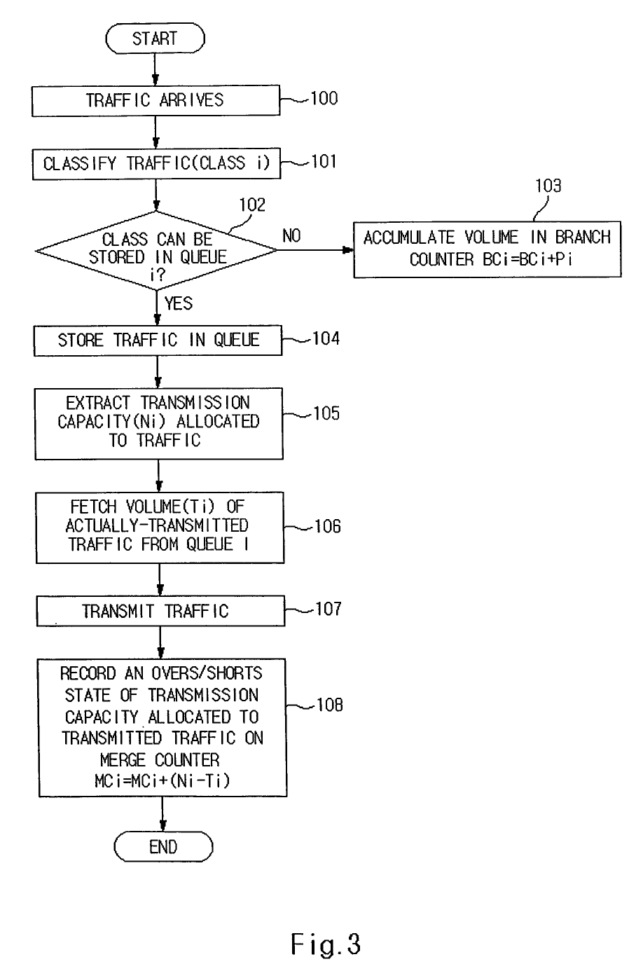

On the other hand, a traffic transmission procedure of a method for controlling traffic congestion using a queue in accordance with the present invention will now be explained with reference to FIG. 3.

When the traffic arrives (step 100), the traffic controller 11 classifies the class of the arrived traffic according to the traffic classification standards previously stored in the traffic classifying table 21 (step 101). Tt is decided whether the classified class can be stored in the queue 12 (step 102). When the class cannot be stored in the queue 12, the volume of the class is accumulated in the branch counter 13 (step 103)

When the classified traffic can be stored in the queue 12, the traffic is stored in the corresponding queue 12 (step 104). Thereafter, the transmitter 14 extracts the transmission capacity Ni allocated to the traffic class to be transmitted with reference to the traffic processing standards previously stored in the traffic processing table 22 (step 105), fetches the traffic from the queue 12 according to the transmission capacity (step 106) and transmits the traffic (S107). Here, the volume Ti of the actually-fetched and transmitted traffic is determined under the mechanism of the queue 12. An overs/shorts state of the transmission capacity allocated to the transmitted traffic is recorded on the merge counter 15 (step 108).

The values counted in the branch counter 13 and the merge counter 15 are stored in the branch and merge counter table 23.

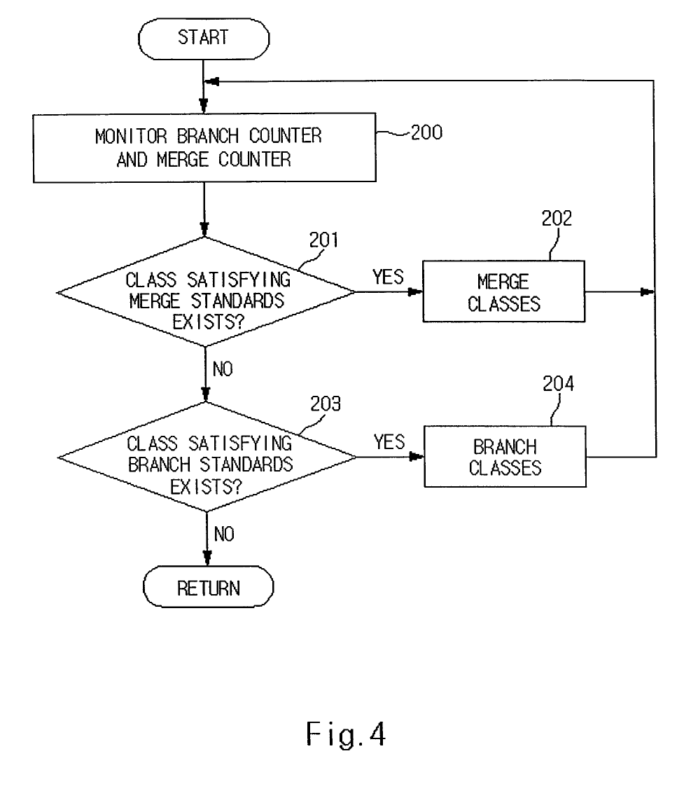

On the other hand, a traffic processing procedure of the method for controlling traffic congestion using the queue in accordance with the present invention will now be explained with reference to FIG. 4.

The branch and merge counter monitoring unit 31 monitors the branch and merge counter table 23 to detect whether a value of the branch and merge counter table 23 has been changed (step 200). According to the monitoring result of the branch and merge counter monitoring unit 31, the merge standards deciding unit 32 decides whether a class satisfying the merge standards exists (step 201).

Here, whether the class satisfies the merge conditions is determined on a node excluding a leaf node, namely a virtual traffic class. When the value MCi of the merge counter 15 of the corresponding node (virtual traffic class) exceeds the merge standards of the node, the node is deemed to satisfy the merge conditions.

When the class satisfying the merge standards exists as the decision result of the merge standards deciding unit 32, the merge processing unit 33 merges the class (step 202) and updates the information stored in the traffic classifying table 21, the traffic processing table 22 and the branch and merge counter table 23. When the class satisfying the merge standards does not exist, the branch standards deciding unit 34 decides whether a class satisfying the branch standards exists (step 203).

At this time, whether the class satisfies the branch conditions is determined on the leaf node. When the value BCi of the branch counter 13 of the corresponding node (traffic class) exceeds the branch standards of the node, the node is deemed to satisfy the branch conditions.

When the class satisfying the branch standards exists, the branch processing unit 35 branches the class (step 204) and updates the information stored in the traffic classifying table 21, the traffic processing table 22 and the branch and merge counter table 23.

The value of the merge counter 15 of the node excluding the leaf node, namely the virtual traffic class is a sum of the merge counter values of the whole subordinated leaf nodes. That is, the merge standards deciding unit 32 performs a process for deciding whether the whole traffic classes branched from the corresponding node should be merged.

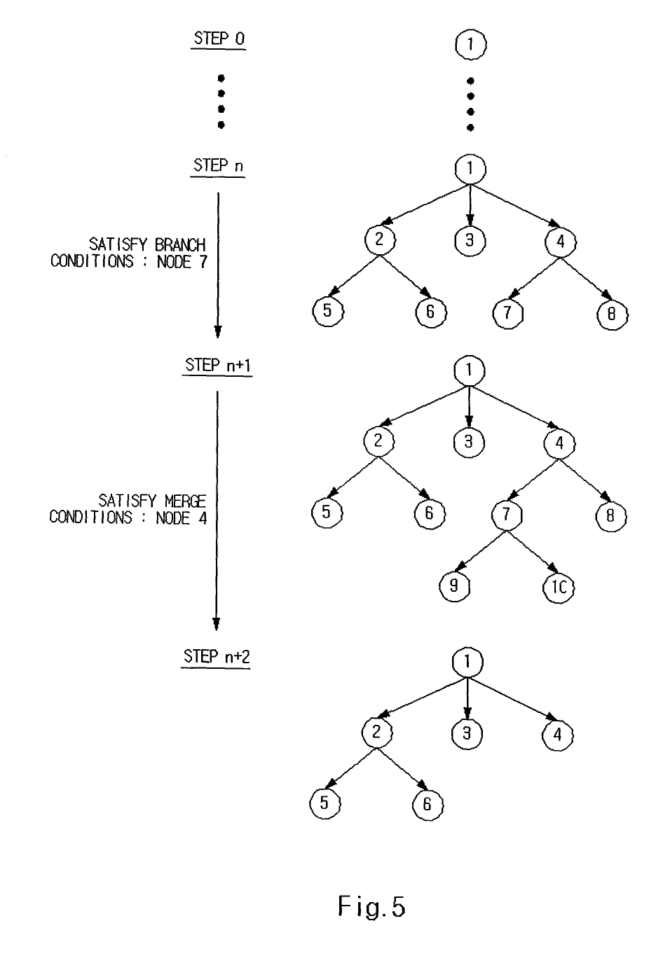

FIG. 5 is a tree diagram illustrating branch and merge processes of the traffic class.

The leaf nodes imply queues of each traffic class and the other nodes imply virtual traffic classes. In step n, node 7 satisfies the branch conditions, and in step n+1, node 7 is branched to generate nodes 9 and 10. In step n+1, node 4 satisfies the merge conditions, and in step n+2, the whole nodes branched from node 4 are merged.

As discussed earlier, in accordance with the present invention, the branch and merge control is performed on the basis of traffic congestion, which reduces time consumption, improves network efficiency and guarantees the QoS of the whole traffic flows.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

What is claimed is:

1. An apparatus for controlling traffic congestion using a queue, comprising:
a traffic processing unit for storing an arrived traffic in a queue, transmitting the stored traffic, branch-counting a discarded traffic, and merge-counting a transmitted traffic;
a traffic processing information storing unit for storing processing information branch and merge-counted in the traffic processing unit; and
a queue managing unit for branching and merging traffic classes according to the counted processing information.

2. The apparatus according to claim 1, wherein the traffic processing unit comprises:
a traffic controller for classifying a traffic class of the arrived traffic and storing it in a queue;
a branch counter for accumulating the traffic which is not stored in the queue but discarded;
a transmitter for transmitting the traffic stored in the queue according to a transmission capacity allocated to the corresponding traffic class; and
a merge counter for counting a difference between the transmission capacity allocated to the traffic class and the volume of the traffic transmitted from the transmitter.

3. The apparatus according to claim 2, wherein the traffic processing information storing unit comprises:
a traffic classifying table for storing classification standards of the traffic;
a traffic processing table for storing a queue size and transmission capacity allocated to each traffic class, and also storing discard standards and transmission standards of the traffic; and
a branch and merge counter table for storing values counted in the branch counter and the merge counter and branch and merge standards.

4. The apparatus according to claim 1, wherein the queue managing unit comprises:
a branch and merge counter monitoring unit for monitoring the counted information stored in the traffic processing information storing unit;
a merge standards deciding unit for comparing the monitoring result of the branch and merge counter monitoring unit and the previously-set merge standards, and deciding merge conditions according to the comparison result;
a merge processing unit for merging the class according to the decision result of the merge standards deciding unit;
a branch standards deciding unit for comparing the monitoring result of the branch and merge counter monitoring unit and the previously-set branch standards, and deciding branch conditions according to the comparison result; and
a branch processing unit for branching the class according to the decision result of the branch standards deciding unit.

5. A method for controlling traffic congestion using a queue, comprising:
a first step for storing a transmitted traffic in a queue, transmitting the stored traffic, branch-counting a discarded traffic, and merge-counting a transmitted traffic;
a second step for storing branch and merge-counted processing information; and
a third step for branching and merging a traffic class according to the counted processing information.

6. The method according to claim 5, wherein the first step comprises the steps of:
storing the arrived traffic in the queue;
branch-counting and storing a volume of the traffic which is not stored in the queue;
transmitting the traffic stored in the queue according to a transmission capacity allocated to a class; and
merge-counting and storing an overs/shorts state of the transmission capacity.

7. The method according to claim 5, wherein the third step comprises the steps of:
monitoring the branch and merge-counted processing information;
deciding whether the merge-counted processing information satisfies the previously-set merge standards, and merging the class when it satisfies the merge standards; and
deciding whether the branch-counted processing information satisfies the previously-set branch standards, and branching the class when it satisfies the merge standards.
